(19) United States
(12) Patent Application Publication
(10) Pub. No.: US 2026/0171087 A1
(43) Pub. Date: Jun. 18, 2026

(54) APPARATUS FOR PROCESSING SPEECH AND METHOD THEREOF

(71) Applicants: Hyundai Motor Company, Seoul (KR); Kia Corporation, Seoul (KR)

(72) Inventor: Seong Hun Noh, Hwaseong-si (KR)

(21) Appl. No.: 19/214,425

(22) Filed: May 21, 2025

(30) Foreign Application Priority Data
Dec. 18, 2024 (KR) 10-2024-0190378

(51) Int. Cl. G10L 15/22; G10L 25/30

(52) U.S. Cl. CPC G10L 15/22; G10L 25/30; G10L 2015/225

(57) ABSTRACT

In an embodiment, a speech processor is configured to obtain a target embedding including a feature of target data by applying the target data associated with a speech to a speech processing model trained to output a feature of a signal as a number, to obtain a context vector and response text estimated as text of the target data by applying the target embedding to a first decoder trained to output a probability of text based on an attention mechanism, to determine whether an operation of obtaining the response text is terminated, by applying the target embedding and the context vector to a second decoder trained to determine whether an embedding is terminated, and to output the response text based on whether the response text and the target embedding are terminated.

### CROSS-REFERENCE TO RELATED APPLICATIONS

This application claims the benefit of priority to Korean Patent Application No. 10-2024-0190378, filed in the Korean Intellectual Property Office on Dec. 18, 2024, the entire contents of which are incorporated herein by reference.

### TECHNICAL FIELD

The present disclosure relates to a speech processing apparatus and a method thereof, and more particularly, relates to a technology for generating sentences by applying the embedding regarding a speech to a transformer-based language model.

### BACKGROUND

Modern robotics and conversational artificial intelligence (AI) systems rely heavily on speech-to-text conversion technologies to recognize a user's speech and to generate an appropriate response based on the recognized result. These technologies operate in a method of converting a speech signal into text, and then generating sentences or determining the user's utterance intent based on the converted text.

The process of converting a speech signal into text takes time, which may make it difficult to immediately process the user's request in robots and conversational AI systems that require real-time processing. Moreover, there are frequent cases where the text converted from the speech signal is recognized, differently from an actual utterance. For example, if the user utters “Tell me the price of Ionic 5,” the text conversion process may incorrectly recognize it as “Tell me the price of Ayuni 5.” The error may prevent the user from obtaining the intended result.

Furthermore, if an EPD technology that cuts and delivers the speech signal ends too early, only a portion of the speech data may be processed, resulting in inaccurate results. For example, if the EPD ends at “open” if the user utters “Open—the door”, the output may be different from “Open the door” that is the actual intent. This is due to imperfections in the text conversion process and limitations in a method of processing the signal. In particular, this may be a serious limitation in systems (e.g., robot control, speech assistants, and conversational AI) where real-time responsiveness and accuracy are critical.

To solve these issues, it is desirable to develop a technology that eliminates a text conversion stage and directly utilizes embedding data extracted in real time from the speech signal.

### SUMMARY

Embodiments of the present disclosure were made to solve the above-mentioned problems occurring in the prior art while advantages achieved by the prior art are maintained intact.

An embodiment of the present disclosure provides a speech processing apparatus that performs processing in real time without a text conversion process by utilizing embeddings directly extracted from a speech signal, and a method thereof.

An embodiment of the present disclosure provides a speech processing apparatus that simultaneously performs text generation and speech presence/absence determination through a single embedding by converting a speech signal into an embedding form and simultaneously extracting text and status information based on the converted result by using a text decoder and a speech activity decoder, and a method thereof.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, a speech processing apparatus may include a memory that stores a computer-executable instruction, and a processor that executes the instruction by accessing the memory. The processor may obtain a target embedding including a feature of target data by applying the target data regarding a speech to a speech processing model trained to output a feature of a signal as a number, may obtain a context vector and response text estimated as text of the target data by applying the target embedding to a first decoder trained to output a probability of text based on an attention mechanism, may determine whether an operation of obtaining the response text is terminated, by applying the target embedding and the context vector to a second decoder trained to determine whether an embedding is terminated, and may output the response text based on whether the response text and the target embedding are terminated.

In an embodiment, the processor may obtain training noise data based on at least one of first sub-noise data obtained in target space, or second sub-noise data generated based on a standard normal distribution, or any combination thereof, may obtain training speech data based on at least one of first sub-speech data recorded by a user, or second sub-speech data generated based on a speech synthesis model, or any combination thereof, may generate training target data through signal-to-noise ratio (SNR) mixing of the training noise data and the training speech data, and may obtain a training target embedding by applying the training target data to the speech processing model.

In an embodiment, the processor may obtain a first temporary output by applying the training target embedding to a text decoder, may obtain a second temporary output by applying the training target embedding to a speech activity decoder, and may train the speech processing model through a first loss based on the first temporary output and the text decoder, and a second loss based on the second temporary output and the speech activity decoder.

In an embodiment, the processor may identify training first response text obtained from the first decoder at a time point preceding a target time point, if a time point at which the training target embedding is applied to the first decoder is the target time point, and may obtain a training context vector and training second response text by applying the training target embedding and the training first response text to the first decoder. The training second response text may be applied to a training input of the first decoder at a time point following the target time point.

In an embodiment, the processor may obtain a termination probability regarding whether the obtaining of the training second response text is terminated, by applying the training target embedding and the training context vector to the second decoder, and may determine whether to terminate an operation of obtaining the training second response text, based on comparison between the termination probability and a predetermined value.

In an embodiment, the processor may obtain a loss of the first decoder based on the first decoder and the training second response text, and a loss of the second decoder based on the second decoder and the termination probability, on a basis of a response generating model including the first decoder and the second decoder and may train the response generating model based on the loss of the first decoder and the loss of the second decoder.

In an embodiment, the processor may obtain a temporary output by applying the target embedding and the context vector to the second decoder, and may determine whether to terminate the operation of obtaining the response text, based on comparison between the temporary output and a predetermined value.

In an embodiment, the processor may convert the response text into a speech and output the speech to a user entering the target data.

In an embodiment, the processor may obtain utterance intent of the response text by applying the response text to an utterance intent prediction model based on obtaining the response text, may obtain action data by applying the utterance intent to an action database according to the utterance intent, and may transmit the action data to a robot connected to the speech processing apparatus.

According to an embodiment of the present disclosure, a speech processing method may include obtaining a target embedding including a feature of target data by applying the target data regarding a speech to a speech processing model trained to output a feature of a signal as a number, obtaining a context vector and response text estimated as text of the target data by applying the target embedding to a first decoder trained to output a probability of text based on an attention mechanism, determining whether an operation of obtaining the response text is terminated, by applying the target embedding and the context vector to a second decoder trained to determine whether an embedding is terminated, and outputting the response text based on whether the response text and the target embedding are terminated.

In an embodiment, the outputting of the response text may include obtaining training noise data based on at least one of first sub-noise data obtained in target space, or second sub-noise data generated based on a standard normal distribution, or any combination thereof, obtaining training speech data based on at least one of first sub-speech data recorded by a user, or second sub-speech data generated based on a speech synthesis model, or any combination thereof, generating training target data through SNR mixing of the training noise data and the training speech data, and obtaining a training target embedding by applying the training target data to the speech processing model.

In an embodiment, the outputting of the response text may include obtaining a first temporary output by applying the training target embedding to a text decoder, obtaining a second temporary output by applying the training target embedding to a speech activity decoder, and training the speech processing model through a first loss based on the first temporary output and the text decoder, and a second loss based on the second temporary output and the speech activity decoder.

In an embodiment, the outputting of the response text may include identifying training first response text obtained from the first decoder at a time point preceding a target time point, if a time point at which the training target embedding is applied to the first decoder is the target time point, and obtaining a training context vector and training second response text by applying the training target embedding and the training first response text to the first decoder. The training second response text may be applied to a training input of the first decoder at a time point following the target time point.

In an embodiment, the outputting of the response text may include obtaining a termination probability regarding whether the obtaining of the training second response text is terminated, by applying the training target embedding and the training context vector to the second decoder, and determining whether to terminate an operation of obtaining the training second response text, based on comparison between the termination probability and a predetermined value.

In an embodiment, the outputting of the response text may include obtaining a loss of the first decoder based on the first decoder and the training second response text, and a loss of the second decoder based on the second decoder and the termination probability, on a basis of a response generating model including the first decoder and the second decoder, and training the response generating model based on the loss of the first decoder and the loss of the second decoder.

In an embodiment, the outputting of the response text may include obtaining a temporary output by applying the target embedding and the context vector to the second decoder, and determining whether to terminate the operation of obtaining the response text, based on comparison between the temporary output and a predetermined value.

In an embodiment, the outputting of the response text may include converting the response text into a speech and outputting the speech to a user entering the target data.

In an embodiment, the outputting of the response text may include obtaining utterance intent of the response text by applying the response text to an utterance intent prediction model based on obtaining the response text, obtaining action data by applying the utterance intent to an action database according to the utterance intent, and transmitting the action data to a robot connected to a speech processing apparatus.

### BRIEF DESCRIPTION OF THE DRAWINGS

The above and other embodiments, features and advantages of the present disclosure will be more apparent from the following detailed description taken in conjunction with the accompanying drawings:

FIG. 1 is a block diagram illustrating a speech processing apparatus, according to an embodiment of the present disclosure;

FIG. 2 is a flowchart for describing a speech processing method, according to an embodiment of the present disclosure;

FIG. 3 is a diagram illustrating components included in a processor in a speech processing apparatus, according to an embodiment of the present disclosure;

FIG. 4 is a flowchart for describing training of a model in a speech processing apparatus, according to an embodiment of the present disclosure;

FIG. 5 is a diagram illustrating a method for processing target embedding in a speech processing apparatus, according to an embodiment of the present disclosure;

FIG. 6 is a flowchart for describing a method of obtaining response text in a speech processing apparatus, according to an embodiment of the present disclosure;

FIG. 7 is a flowchart for describing a method of converting response text into a speech and outputting the speech in a speech processing apparatus, according to an embodiment of the present disclosure; and

FIG. 8 is a diagram illustrating a computing system related to a speech processing apparatus or a speech processing method, according to an embodiment of the present disclosure.

With regard to description of drawings, the same or similar components will be marked by the same or similar reference signs;

### DETAILED DESCRIPTION OF ILLUSTRATIVE EMBODIMENTS

Hereinafter, some embodiments of the present disclosure will be described in detail with reference to the accompanying drawings. In adding reference numerals to components of each drawing, it should be noted that the same components include the same reference numerals, although they are indicated on another drawing. Furthermore, in describing the embodiments of the present disclosure, detailed descriptions associated with well-known functions or configurations will be omitted if they may make subject matters of the present disclosure unnecessarily obscure. Hereinafter, various embodiments of the present disclosure may be described with reference to accompanying drawings. Accordingly, those of ordinary skill in the art will recognize that modification, equivalent, and/or alternative on the various embodiments described herein may be variously made without departing from the scope and spirit of the present disclosure. With regard to description of drawings, similar components may be marked by similar reference numerals.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, the terms, such as “first”, “second”, and the like used herein may refer to various elements of various embodiments of the present disclosure, but do not limit the elements. For example, “a first user device” and “a second user device” may indicate different user devices regardless of the order or priority thereof. For example, without departing the scope of the present disclosure, a first complement may be referred to as a second component, and similarly, a second complement may be referred to as a first complement.

In this specification, the expressions “possess”, “may possess”, “include” and “comprise”, or “may include” and “may comprise” used herein indicate existence of corresponding features (e.g., elements such as numeric values, functions, operations, or components) but do not exclude presence of additional features.

It will be understood that if an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, if an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a CPU or an application processor) which performs corresponding operations by executing one or more software programs which are stored in a memory device. The terms used in the specification are only used to describe a specific embodiment and are not intended to limit the scope of the present disclosure. The terms of a singular form may include plural forms unless otherwise specified. All the terms used herein, which include technical or scientific terms, may include the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even though terms are terms which are defined in the specification, they may not be interpreted to exclude embodiments of the present disclosure.

In the present disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Moreover, in describing a component of an embodiment of the present disclosure, the expressions at least one of “A or B”, “at least one of A and B”, “at least one of A or B”, “A, B, or C”, “at least one of A, B, and C”, or “at least one of A, B, or C, or any combination thereof” may include any and all combinations of one or more of the associated listed items. In particular, expressions “at least one of A, B, or C, or any combination thereof” may include A, B, or C, or any combination thereof such as AB, ABC, or the like.

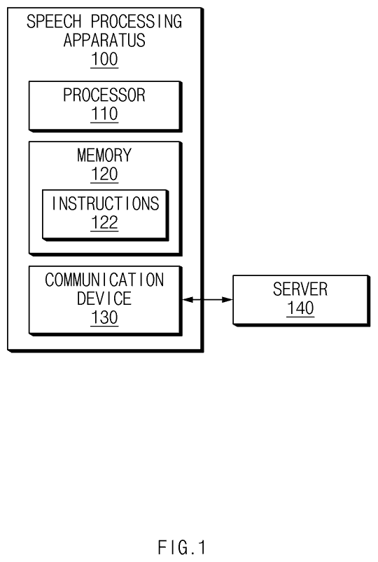

Hereinafter, embodiments of the present disclosure will be described in detail with reference to FIGS. 1 to 8.

FIG. 1 is a block diagram illustrating a speech processing apparatus, according to an embodiment of the present disclosure.

A speech processing apparatus 100 according to an embodiment may include a processor 110, a memory 120 including instructions 122, and a communication device 130.

The speech processing apparatus 100 may indicate a device that applies an embedding regarding a speech to a transformer-based language model to generate a sentence.

For example, the speech processing apparatus 100 may convert features of an input speech signal into the embedding, which is a numerical vector, with a speech processing model. The speech processing apparatus 100 may use the embedding including key information of the speech signal for text generation and training.

For example, the speech processing apparatus 100 may generate response text corresponding to speech data by inputting the embedding into a first decoder trained by using an attention mechanism. The speech processing apparatus 100 may predict text by reflecting the context of the input speech through a first decoder.

For example, the speech processing apparatus 100 may determine whether an operation of generating response text ends by inputting an embedding and a context vector to a second decoder. The speech processing apparatus 100 may determine the termination of a conversation by comparing a termination probability with a predetermined reference value.

For example, the speech processing apparatus 100 may generate signal-to-noise ratio (SNR)-based training data by mixing noise data and speech data. The speech processing apparatus 100 may train a model that robustly operates even in a noisy environment.

For example, the speech processing apparatus 100 may perform training of a speech processing model based on a loss value calculated by each of a text decoder and a speech activity decoder. The speech processing apparatus 100 may optimize the performance of the speech processing model by combining losses of the text decoder and the speech activity decoder.

For example, the speech processing apparatus 100 may convert the generated text response into a speech by using a text-to-speech (TTS) technology. In this way, the speech processing apparatus 100 may provide a natural speech response to a user.

For example, the speech processing apparatus 100 may analyze the user's utterance intent by applying response text to an utterance intent prediction model. The speech processing apparatus 100 may execute necessary operations by generating action data based on the analyzed utterance intent in devices such as robots.

For example, the speech processing apparatus 100 may immediately generate a response without converting the speech signal to text by processing a speech signal in real time. In this way, the speech processing apparatus 100 may maintain accuracy even in various noisy environments and may provide high flexibility and real-time to determine whether a conversation ends.

The processor 110 may execute software and may control at least one other component (e.g., a hardware or software component) connected to the processor 110. The processor 110 may also perform various data processing or operations. For example, the processor 110 may store target data, target embeddings, or response text in the memory 120. For reference, the processor 110 may perform all operations performed by the speech processing apparatus 100. Therefore, for convenience of description in this specification, an operation performed by the speech processing apparatus 100 are mainly described as an operation performed by the processor 110.

Furthermore, for convenience of description in this specification, the processor 110 is mainly described as a single processor, but is not limited thereto. For example, the speech processing apparatus 100 may include processors. Each of the processors may perform all operations related to an operation of generating a sentence by applying the embedding regarding a speech to a transformer-based language model.

The memory 120 may temporarily and/or permanently store various pieces of data and/or information required to generate sentences by applying the embedding regarding a speech to the transformer-based language model. For example, the memory 120 may store target data, target embeddings, or response text.

The communication device 130 may support communication between the speech processing apparatus 100 and a server 140. For example, the communication device 130 may include one or more components for communicating between the speech processing apparatus 100 and the server 140. For example, the communication device 130 may include a short range wireless communication device, a microphone, or the like. In this case, short-range communication technologies include wireless LAN (Wi-Fi), Bluetooth, ZigBee, Wi-Fi Direct (WFD), ultra-wideband (UWB), infrared data association (IrDA), Bluetooth Low Energy (BLE), and near field communication (NFC), and the like, but are not limited thereto.

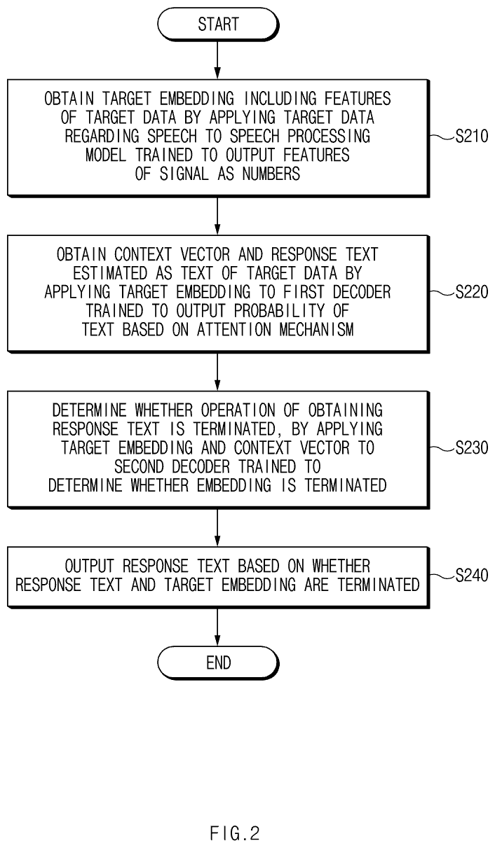

FIG. 2 is a flowchart for describing a speech processing method, according to an embodiment of the present disclosure.

According to an embodiment, in S210, a processor (e.g., the processor 110 of FIG. 1) may obtain a target embedding including features of target data by applying the target data regarding a speech to a speech processing model trained to output features of a signal as numbers.

For example, the target data may be data regarding a speech, and may mean an input speech signal or data related to the input speech signal. The target data may include data extracted from a speech signal entered by a user, a signal itself, a mixed signal including noise, or physical characteristics of the speech (e.g., time domain information or frequency domain information). The target data may be used as an input of the speech processing model and may be used to digitize the main features of the speech signal.

For example, the speech processing model may refer to a machine learning (or deep learning)-based model trained to output features of a signal as numbers. The speech processing model may process the input speech data and may convert key information of the speech into a form (i.e., Embedding) expressed with numbers. The speech processing model may be designed based on various neural network structures such as Convolution, Transformer, or RNN. The speech processing model may be designed to extract robust features by utilizing noise data and SNR mixing data during a training process. The speech processing model may generate embedding data required for subsequent processing (e.g., generating text through a decoder) by extracting important features (e.g., feature vector) from the input speech data.

For example, the target embedding may be the output result of the speech processing model, and may represent data in a form of a vector obtained by digitizing the main features of the input speech data. The target embedding may be expressed by compressing the contextual, temporal, and frequency information of speech data. The target embedding may be in a form of a multidimensional vector that may be used in the subsequent decoder (a first decoder or a second decoder). The target embedding may include essential information of speech data without text conversion. The target embedding may be an intermediate representation indicating characteristics of the input speech signal and may provide task-based data such as generating response text and predicting speech activity.

In S220, the processor may obtain a context vector and response text estimated as the text of the target data by applying the target embedding to the first decoder trained to output the probability of the text based on the attention mechanism.

For example, the first decoder may be a decoder trained based on the attention mechanism and may generate a probability distribution for the response text by receiving the target embedding and the previous response text as inputs. In other words, the first decoder may represent a component that generates the response text by interpreting the input embedding data. The first decoder is composed of multiple stages (layers) and may calculate the interaction between the input embedding and context information by using the attention mechanism. In detail, the first decoder may model the relationship between the embedding and the previous response text by utilizing trainable weights. The first decoder may mean a decoder that outputs a probability distribution to generate text corresponding to the target data (speech data), selects the next text token through softmax, and generates the entire response text by repeating the operations.

For example, the response text may be the text generated by the first decoder (i.e., the output decoder), and may indicate results in a character format corresponding to the target data. The response text may be composed of a word (or token) with the highest value in the probability distribution output from the first decoder. The first decoder operates in a method of sequentially generating words and predicting the next word based on the previous word. As a result from reflecting the user's speech input, the generated text may be finally delivered to the user. In detail, if the target data of “Tell me the weather” is input from the user, a processor may generate response text such as “Today's weather is clear.” to provide information corresponding to the target data. The response text may be used for an operation (e.g., text-to-speech conversion, utterance intent analysis, or the like) of the processor.

For example, as a vector generated by the first decoder, the context vector may indicate a vector that numerically expresses the correlation between the input data (target embedding) and the previous response text. The context vector may be generated by the attention mechanism and may be expressed by integrating important information from the input embedding and the previous response text. The context vector may be used in all layers of the first decoder and may include information required to predict the next word. The context vector may be calculated based on an attention score and a trainable weight.

In S230, the processor may determine whether an operation of obtaining the response text is terminated, by applying the target embedding and the context vector to the second decoder trained to determine whether the embedding is terminated.

For example, the second decoder may indicate a decoder trained to determine whether a response text generation operation ends, by taking the target embedding and the context vector as inputs. The second decoder may output a probability indicating whether the operation ends. For example, the case where a value of 0.85 is output may mean that the response text generation operation ends at a probability of 85%. The second decoder is trained by using a binary cross-entropy loss based on a difference from the actual termination status (i.e., a ground truth label) in a training process.

In S240, the processor may output the response text based on whether the response text and the target embedding are terminated. For example, the processor may output the response text to a screen through a display or a GUI interface. The processor may convert the generated response text into a speech using text-to-speech (TTS) technology and may output the speech to the user.

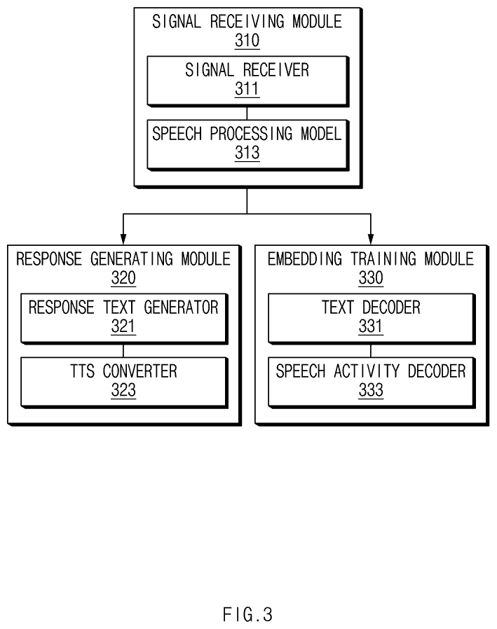

FIG. 3 is a diagram illustrating components included in a processor in a speech processing apparatus, according to an embodiment of the present disclosure.

FIG. 3 illustrates a structural block diagram showing a configuration of a speech processing apparatus (e.g., the speech processing apparatus 100 of FIG. 1) and the interactions between modules. The speech processing apparatus may receive a speech signal as an input, may generate response text, or train speech embedding data, and may perform various speech processing tasks.

For example, a signal receiving module 310 may receive speech data from the outside, may convert the speech data into digital data, and may deliver the digital data to a speech processing model 313. That is, the signal receiving module 310 may be responsible for collecting and preprocessing the speech data.

For example, a signal receiver 311 may receive a speech signal uttered by a user in an external environment. The signal receiver 311 may convert the received speech signal into digital data in a form capable of analyzing the features of the signal.

For example, the speech processing model 313 may convert the input speech signal into embedding data (i.e., target embedding), which is obtained by digitizing main features, by analyzing the input speech signal. The speech processing model 313 may generate embedding data expressed in a vector form by compressing temporal and frequency features of speech data.

For example, a response generating module 320 may generate response text to be delivered to a user based on the embedding data received from the speech processing model 313. The response generating module 320 may convert the generated response text into a speech and may output the speech to the user.

For example, a response text generator 321 may receive the embedding data and may generate a response in a text format. The response text generator 321 may contextually analyze the input embedding data based on an attention mechanism, may predict the next word, and may generate final text (i.e., response text).

For example, a text-to-speech (TTS) converter 323 may convert the generated text response into a speech and may deliver the speech to the user. In detail, the TTS converter 323 may output a natural speech by utilizing a TTS technology.

For example, an embedding training module 330 may provide a function necessary to train the speech processing model 313. In particular, the embedding training module 330 may convert the input speech data into an embedding, may train the embedding, and may optimize performance.

For example, a text decoder 331 may indicate a decoder that predicts text based on the embedding by using the embedding data generated by the speech processing model 313 as an input. The text decoder 331 may perform training by calculating a loss based on a difference between an actual ground truth text and text predicted during training.

For example, a speech activity decoder 333 may refer to a decoder that determines whether data includes a speech (activity), by using the embedding data of a speech processing model as an input. The speech activity decoder 333 may be used to determine a section in which there is a speech signal, or to determine whether a conversation operation ends. The speech activity decoder 333 may train whether the conversation operation ends, by utilizing a binary cross-entropy loss.

For example, the signal receiving module 310 may collect speech data input from the outside, may deliver the speech data to the speech processing model 313, and may generate embedding data obtained by digitizing main features.

For example, the response generating module 320 may generate response text based on the embedding data generated by the signal receiving module 310. The response generating module 320 may generate text suitable for information or services requested by the user, and then may convert the generated text into a speech to output the speech to the user.

For example, the embedding training module 330 may receive the embedding data generated by the signal receiving module 310 and may perform training and optimization of the speech processing model 313. In particular, the embedding training module 330 may train a task of generating text and detecting speech presence/absence through the text decoder 331 and the speech activity decoder 333.

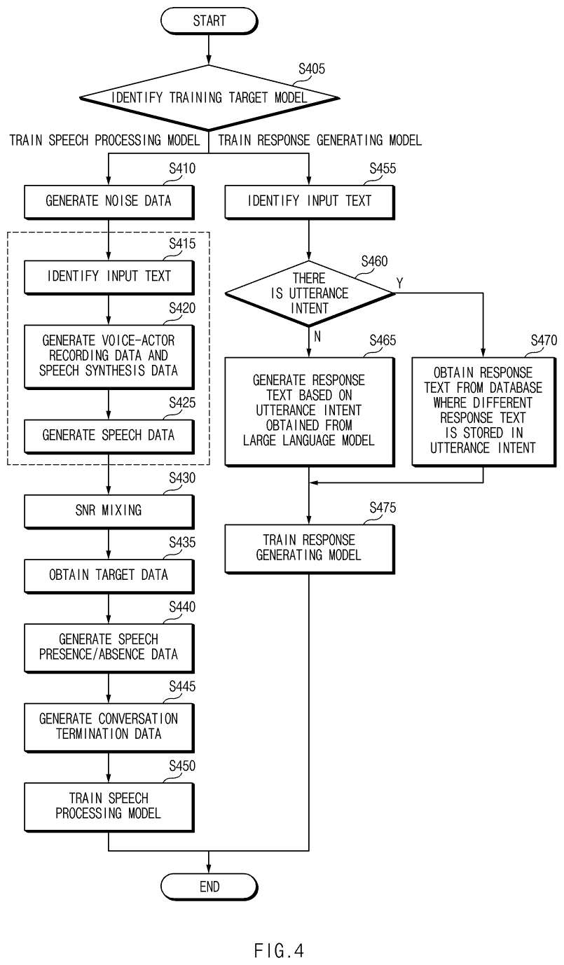

FIG. 4 is a flowchart for describing training of a model in a speech processing apparatus, according to an embodiment of the present disclosure.

FIG. 4 is a flowchart showing a training and response generating process of a speech processing apparatus (e.g., the speech processing apparatus 100 of FIG. 1). Each of the operations illustrated in FIG. 4 may be described as a process in which a processor trains a speech processing model and a response generating model, or outputs text based on generated data.

In S405, the processor (e.g., the processor 110 of FIG. 1) according to an embodiment may identify a training target model. For example, the training target model may include the speech processing model and the response generating model.

The response generating model may indicate a model designed to generate response text to be delivered to a user, or to determine whether response generation ends, based on speech data or embedding data. The response generating model may generate a response by including a first decoder (i.e., a text decoder) and a second decoder (i.e., a conversation termination decoder).

The first decoder may calculate a probability distribution of the response text by taking the embedding data (i.e. target embedding) as an input, and may generate the response text. The first decoder may generate a text response corresponding to the input speech data through target embedding. The second decoder may determine whether an operation of generating the response text ends. The second decoder may calculate a termination probability by taking the target embedding and the context vector as inputs, and may determine whether the response text generating operation is completed, through the termination probability.

In S410, the processor may generate noise data. For example, the processor may generate the noise data to be mixed with speech data, and may generate the noise data based on various noise conditions (e.g., cafe noise, keyboard noise, park noise, or the like) capable of occurring in actual environments.

In S415, the processor may identify input text. For example, the processor may select input text data to be used for training.

In S420, the processor may generate voice-actor recording data and speech synthesis data. For example, the processor may generate speech data through voice-actor speech data, which is recorded by a user, and a speech synthesis model and may use the speech data as training data.

In S425, the processor may generate the speech data. For example, the processor may generate speech data corresponding to text data, and may use the speech data as training-specific speech data.

In S430, the processor may perform signal-to-noise ratio (SNR) mixing. For example, the processor may mix the generated speech data and the noise data through the SNR mixing. The processor may perform the SNR mixing to train a model robust to various acoustic conditions capable of occurring in actual environments.

In S435, the processor may obtain target data. For example, the processor may determine that data generated as the result of SNR mixing is the target data that is a training target. The target data may indicate data including the main features of a speech signal.

In S440, the processor may generate speech presence/absence data. At each time point of speech data, the processor may generate the speech presence/absence data indicating whether a speech is included at the corresponding time point.

In S445, the processor may generate conversation termination data. For example, the processor may generate the conversation termination data indicating whether a conversation ends, and may use the conversation termination data during training.

In S450, the processor may perform embedding training. For example, the processor may train a speech processing model, which generates an embedding based on the trained data, by utilizing a text decoder and a speech activity decoder.

The processor may obtain training noise data based on at least one of first sub-noise data obtained in target space, or second sub-noise data generated based on a standard normal distribution, or any combination thereof.

For example, the target space may represent an environment where source data required to collect or synthesize training data is collected. The target space may include speech and noise data collected in an actual environment.

For example, the first sub-noise data may refer to actual environmental noise data actually collected in the target space. The first sub-noise data may include noise data recorded through an actual microphone, or physical signals from the actual environment, such as keyboard sounds, wind sounds, or vehicle noises.

For example, the second sub-noise data may mean artificial noise data synthesized based on a mathematical method (e.g., a standard normal distribution). The second sub-noise data may be generated to simulate a noise signal of an actual environment.

For example, training noise data may represent training noise data generated by combining the first sub-noise data and the second sub-noise data. The training noise data may be designed to maximize diversity by combining actual noise data and synthetic noise data, and to enable the speech processing model to operate robustly in various noise environments.

The processor may obtain training speech data based on at least one of first sub-speech data recorded by a user, or second sub-speech data generated based on a speech synthesis model, or any combination thereof.

For example, the first sub-speech data may refer to actual speech data, which is actually recorded by the user, and may include raw speech data collected based on a person's utterance, natural utterance patterns collected based on a person's utterance, and features of a speech.

For example, the second sub-speech data may indicate synthetic speech data generated through a speech synthesis model, may be generated by using deep learning-based speech synthesis technology (TTS), may include acoustic characteristics similar to an actual speech, and may express various utterance patterns, intonation, and pitch.

For example, the training speech data may represent training-specific speech data generated independently or by combining the first sub-speech data and the second sub-speech data.

The processor may generate training target data through SNR mixing of training noise data and training speech data.

The SNR mixing may be expressed based on Equation 1 below.

$$S N R = \frac{{P}_{signal}}{{P}_{noise}} = \frac{E [ {S}^{2} ]}{E [ {N}^{2} ]} \qquad [ Equation 1 ]$$

The processor may obtain training target embedding by applying training target data to the speech processing model.

The processor may obtain a first temporary output by applying the training target embedding to the text decoder.

For example, the text decoder may indicate a decoder that generates response text based on the corresponding embedding by taking the training target embedding as an input. The text decoder may analyze embedding data and context information by utilizing an attention mechanism, may calculate a probability distribution of the next word, and may sequentially generate text based on the probability distribution.

The output of the text decoder may be expressed based on Equation 2 and Equation 3 below.

$${y}_{u} = P ( {z}_{u , t} \vert x , t , {y}_{1 ... u - 1} ) = softmax ( Linear ( tan h ( Joint ) ) ) \qquad [ Equation 2 ]$$

$$joint = Linear ( x ) + L S T M ( {y}_{1 ... u - 1} ) \qquad [ Equation 3 ]$$

The processor may obtain a second temporary output by applying the training target embedding to the speech activity decoder.

For example, the speech activity decoder may indicate a decoder that determines whether the embedding includes a speech, by taking the training target embedding as an input. The speech activity decoder may be composed of multiple linear layers and may output the presence/absence of the speech as a probability value between 0 and 1.

The output of the speech activity decoder may be expressed based on Equation 4 below.

$$P ( a c {t}_{t} \vert {x}_{t} ) = Linear ( {x}_{t} ) \qquad [ Equation 4 ]$$

For example, the processor may train the speech processing model through a first loss based on the first temporary output and the text decoder, and a second loss based on the second temporary output and the speech activity decoder.

The first loss may be expressed based on Equation 5 below.

$${L}_{T} = - {\sum }_{i} log P ( {y}_{i} \vert {x}_{i} ) \qquad [ Equation 5 ]$$

The second loss may be expressed based on Equation 6 below.

$${L}_{A} = BinaryCrossEntropyLoss ( P ( a c {t}_{t} \vert {x}_{t} ) , {act}_{t} ) \qquad [ Equation 6 ]$$

Here, [act]_t may denote speech presence/absence data.

The loss required for treating the speech processing model may be expressed based on Equation 7 below.

$$L = {L}_{T} + {L}_{A} \qquad [ Equation 7 ]$$

In S455, the processor may identify input text. The processor may identify input text data to be used for training.

In S460, the processor may determine whether there is utterance intent of input text. The processor may generate response text according to the utterance intent, by determining whether the utterance intent is present in the input text, if the utterance intent is present. Alternatively, if no utterance intent is present, the processor may identify the response text from a separate database and/or a large language model.

In S465, the processor may generate response text based on utterance intent obtained from a conversational language model or the large language model.

In S470, the processor may obtain response text from the database where different response text is stored in the utterance intent.

The response text generated in operations S455 to S470 may mean ground truth data required for training the response generating model.

In S475, the processor may train a response text generator based on the generated text data.

For example, if a time point at which the training target embedding is applied to the first decoder is a target time point, the processor may identify training first response text obtained from the first decoder at a time point preceding the target time point.

For example, the target time point may mean a specific time point at which the training target embedding is applied to the first decoder. The target time point is a reference time point at each stage where the response text is generated, and refers to a time step at which the first decoder generates text by processing the input data.

For example, the training first response text may indicate the text generated from the first decoder before the target time point. The first response text may be used as key data for forming the context of the text to be generated after the target time point.

For example, the processor may obtain a training context vector and training second response text by applying the training target embedding and the training first response text to the first decoder.

For example, the training second response text may indicate the text generated from the first decoder after the target time point. The training second response text may be generated based on the training target embedding and the training first response text input at the target time point.

For example, the training second response text may be applied to a training input of the first decoder at a time point following the target time point.

For example, the processor may obtain the termination probability regarding whether the acquisition of the second response text is terminated, by applying the training target embedding and the training context vector to the second decoder. The processor may determine whether to terminate an operation of obtaining the second response text, based on the comparison between the termination probability and a predetermined value.

For example, on the basis of the fact that the first decoder and the second decoder are included in the response generating model, the processor may obtain the loss of the first decoder based on the first decoder and the training second response text, and the loss of the second decoder based on the second decoder and the termination probability.

For example, the processor may train a response generating model based on the loss of the first decoder and the loss of the second decoder.

For example, the loss of the first decoder may mean the loss indicating a difference between a ground truth text and the text output value generated by the first decoder. The loss of the second decoder may mean the loss indicating a difference between the termination probability output by the second decoder and whether actual termination is performed (ground truth label).

For example, the processor may obtain a temporary output by applying the target embedding and context vector to the second decoder. The processor may determine whether to terminate an operation of obtaining the response text, based on the comparison between the temporary output and a predetermined value.

For example, the response generating model is designed based on a transformer structure and is composed of the first decoder and the second decoder. The response generating model may train a function of generating text and determining conversation termination through deep learning-based training, and may provide a response corresponding to a user's request through real-time inference.

For example, the training process of a response generating model may include an operation for generating input data and ground truth data. In detail, the input data may include embedding data (i.e., training target embedding) generated by the speech processing model, and training first response text (i.e., text generated before the target time point).

For example, the training target embedding may be applied to be delivered to the first decoder of the response generating model to analyze a relationship between pieces of input data and to generate an appropriate response.

For example, the processor may generate the training second response text based on the training target embedding and the training first response text. In detail, the processor may generate the training second response text by contextually analyzing input data by utilizing the attention mechanism of the response generating model. The processor may calculate the cross-entropy loss between the generated response text (i.e., the training second response text) and the ground truth text, and may update the training weight of the first decoder through a loss value.

For example, the processor may output the termination probability by applying the training target embedding and the context vector to the second decoder. The processor may calculate the binary cross-entropy loss based on a difference between the termination probability and the actual termination (i.e., ground truth data being a label).

For example, the processor may obtain a final loss by adding the loss of the first decoder and the loss of the second decoder. The processor may update the weight of the response generating model by using an optimization algorithm (e.g., Adam or AdamW).

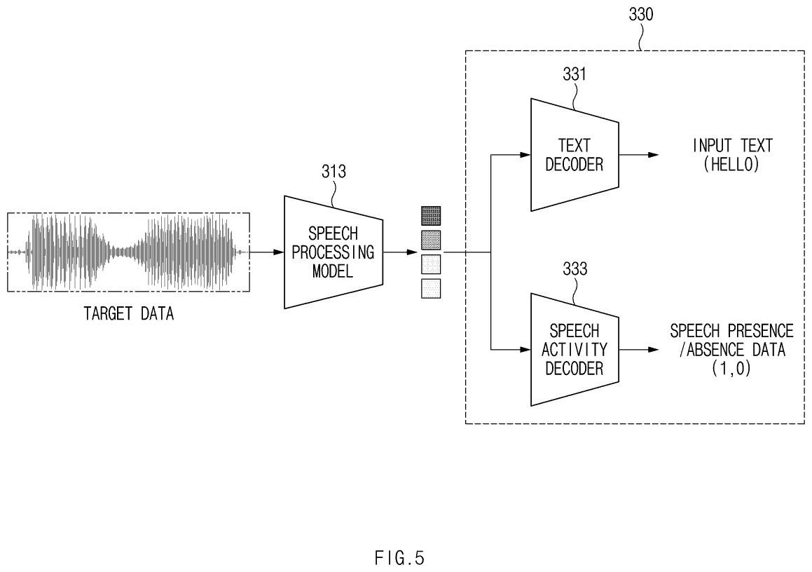

FIG. 5 is a diagram illustrating a method for processing target embedding in a speech processing apparatus, according to an embodiment of the present disclosure.

FIG. 5 is a diagram showing interactions between main components and a data processing flow of a speech processing apparatus (e.g., the speech processing apparatus 100 of FIG. 1), according to an embodiment.

Target data is a speech signal input from outside and includes a speech signal captured in an actual environment or synthesized speech data. The target data may be applied to a speech processing model 313.

The speech processing model 313 converts the input target data into a digitized embedding. The speech processing model 313 is designed based on neural network structures such as Transformer, RNN, and Convolutional Neural Network (CNN).

The embedding training module 330 refers to a module that receives embedding data delivered from the speech processing model 313 and performs tasks of text generation and speech presence/absence determination. The embedding training module 330 is composed of two decoders (e.g., a text decoder and a speech activity decoder).

A text decoder 331 generates response text based on the input embedding data. For example, if the input speech signal is “Hello”, the text decoder 331 may generate a response text of “Hello”.

A speech activity decoder 333 determines speech presence/absence data based on the input embedding data. The speech activity decoder 333 outputs a binary value (e.g., 0 or 1) indicating whether a speech is present at each time point.

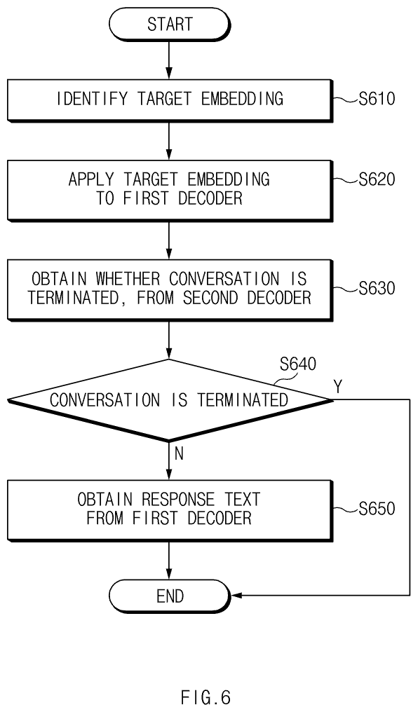

FIG. 6 is a flowchart for describing a method of obtaining response text in a speech processing apparatus, according to an embodiment of the present disclosure.

In S610, a processor according to an embodiment (e.g., the processor 110 of FIG. 1) may identify a target embedding. The processor may identify the target embedding generated by a speech processing model from target data (i.e., a speech signal).

In S620, the processor may apply the target embedding to a first decoder. The processor may calculate a probability distribution for generating a text response through the first decoder and may determine whether a conversation is terminated in the subsequent stage.

In S630, the processor may obtain whether the conversation is terminated from a second decoder. The processor inputs the target embedding and a context vector, which is generated by the first decoder, into the second decoder. The processor may calculate a conversation termination probability based on the input data through the second decoder and may obtain whether the conversation is terminated (i.e., 0 or 1) based on the conversation termination probability.

In S640, the processor may determine whether the conversation is terminated. If a termination status is ‘1’, the processor may determine that the conversation is terminated, through a conversation termination value obtained from the second decoder and may terminate the process. On the other hand, if the termination status is ‘o’, the processor may determine that the conversation is still ongoing, and may perform the next operation.

In S650, the processor may obtain a response text from the first decoder. The processor may generate the response text through the first decoder. The first decoder may complete the response text by sequentially generating the next word based on the target embedding and previously generated text data (i.e., response text generated before a point in time where the target embedding is applied to the first decoder).

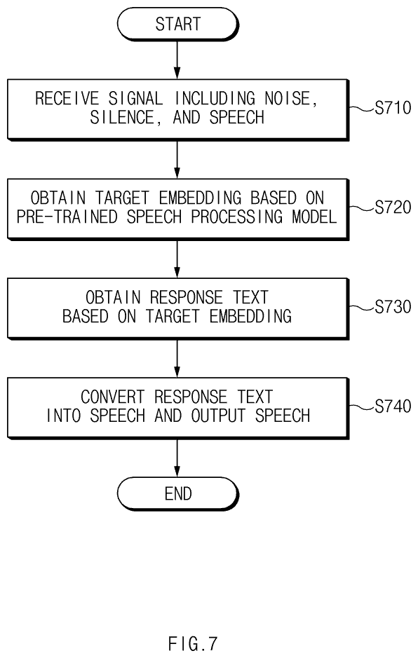

FIG. 7 is a flowchart for describing a method of converting response text into a speech and outputting the speech in a speech processing apparatus, according to an embodiment of the present disclosure.

According to an embodiment, in S710, a processor (e.g., the processor 110 of FIG. 1) may receive a signal including noise, silence, and a speech. The input signal may be obtained through a collection device such as a microphone, and may be collected in various noisy environments. For example, the processor may receive speech data such as “hello” together with ambient noise (e.g., keyboard sounds, vehicle noise, or the like).

In S720, the processor may obtain target embedding based on a speech processing model. For example, the speech signal of “Hello” may be converted into embedding data (i.e., a target embedding) in the form of a feature vector.

In S730, the processor may obtain response text based on the target embedding. For example, if the input signal is “Hello”, the processor may generate the response text such as “Hello, how may I help you?” through a response generating model.

In S740, the processor may convert the response text into a speech and may output the speech. In addition, the processor may obtain the utterance intent of the response text by applying the response text to an utterance intent prediction model based on obtaining the response text. The processor may obtain action data by applying the utterance intent to an action database according to the utterance intent. The processor may transmit the action data to a robot connected to a speech processing apparatus (e.g., the speech processing apparatus 100 of FIG. 1).

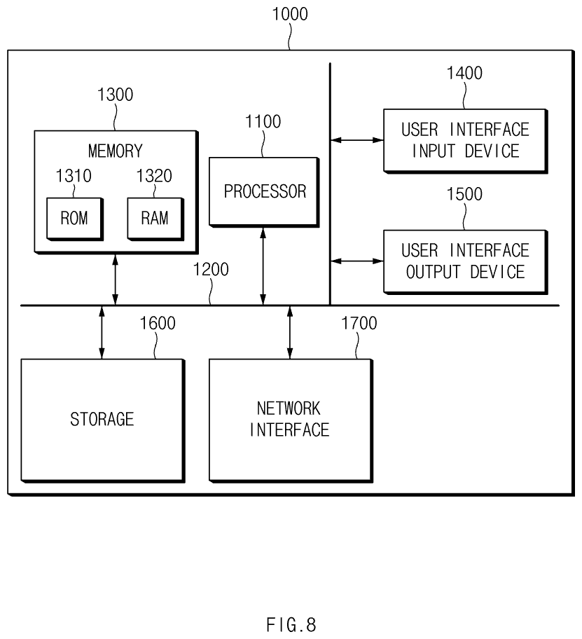

FIG. 8 is a diagram illustrating a computing system related to a speech processing apparatus or a speech processing method, according to an embodiment of the present disclosure.

Referring to FIG. 8, a computing system 1000 related to a speech processing apparatus or a speech processing method may include at least one processor 1100, a memory 1300, a user interface input device 1400, a user interface output device 1500, a storage 1600, and a network interface 1700, which are connected with each other via a bus 1200.

The processor 1100 may be a CPU or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

The above-described embodiments may be implemented with hardware elements, software elements, and/or a combination of hardware elements and software elements. For example, the devices, methods, and components described in embodiments of the present disclosure may be implemented by using general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing device may perform an operating system (OS) or a software application running on the OS. Further, the processing device may access, store, manipulate, process and generate data in response to execution of software. It will be understood by those skilled in the art that although a single processing device may be illustrated for convenience of understanding, the processing device may include a plurality of processing elements and/or a plurality of types of processing elements. For example, the processing device may include a plurality of processors or one processor and one controller. Also, the processing device may include a different processing configuration, such as a parallel processor.

Software may include computer programs, codes, instructions or one or more combinations thereof and configure a processing device to operate in a desired manner or independently or collectively control the processing device. Software and/or data may be permanently or temporarily embodied in any type of machine, components, physical equipment, virtual equipment, computer storage media or units or transmitted signal waves so as to be interpreted by the processing device or to provide instructions or data to the processing device. Software may be dispersed throughout computer systems connected over networks and be stored or executed in a dispersion manner. Software and data may be recorded in a computer-readable storage medium.

The methods according to the above-described embodiments may be recorded in a computer-readable medium including program instructions that are executable through various computer devices. The computer-readable medium may also include program instructions, data files, data structures, and the like, singly or in combination. The program instructions recorded in the medium may be designed and configured specially for the embodiments of the present disclosure or may be known and available to those skilled in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer programs include not only machine language codes created by a compiler, but also high-level language codes that are capable of being executed by a computer by using an interpreter or the like.

The hardware device described above may be configured to act as one or more software modules to perform the operations of the above-described embodiments of the present disclosure, or vice versa.

Even though the embodiments are described with reference to restricted drawings, it may be obviously to one skilled in the art that the embodiments are variously changed or modified based on the above description. For example, adequate effects may be achieved even though the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of a speech processing apparatus according to an embodiment of the present disclosure, and a method therefor are as follows.

According to at least one of embodiments of the present disclosure, a speech processing apparatus may perform processing in real time without a text conversion process by utilizing embeddings directly extracted from a speech signal.

Moreover, according to at least one of embodiments of the present disclosure, a speech processing apparatus may simultaneously perform text generation and speech presence/absence determination through a single embedding by converting a speech signal into an embedding form and simultaneously extracting text and status information based on the converted result by using a text decoder and a speech activity decoder.

Besides, a variety of effects directly or indirectly understood through the present disclosure may be provided.

Hereinabove, although the present disclosure was described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A speech processing apparatus comprising:
a memory configured to store a computer-executable instruction; and
a processor configured to execute the instruction by accessing the memory,
wherein the processor is configured to:
obtain a target embedding including a feature of target data by applying the target data associated with a speech to a speech processing model trained to output a feature of a signal as a number;
obtain a context vector and response text estimated as text of the target data by applying the target embedding to a first decoder trained to output a probability of text based on an attention mechanism;
determine whether an operation of obtaining the response text is terminated, by applying the target embedding and the context vector to a second decoder trained to determine whether an embedding is terminated; and
output the response text based on whether the response text and the target embedding are terminated.

2. The speech processing apparatus of claim 1, wherein the processor is configured to:
obtain training noise data based on at least one of first sub-noise data obtained in target space, or second sub-noise data generated based on a standard normal distribution, or any combination thereof;
obtain training speech data based on at least one of first sub-speech data recorded by a user, or second sub-speech data generated based on a speech synthesis model, or any combination thereof;
generate training target data through signal-to-noise ratio (SNR) mixing of the training noise data and the training speech data; and
obtain a training target embedding by applying the training target data to the speech processing model.

3. The speech processing apparatus of claim 2, wherein the processor is configured to:
obtain a first temporary output by applying the training target embedding to a text decoder;
obtain a second temporary output by applying the training target embedding to a speech activity decoder; and
train the speech processing model through a first loss based on the first temporary output and the text decoder, and a second loss based on the second temporary output and the speech activity decoder.

4. The speech processing apparatus of claim 2, wherein the processor is configured to:
identify training first response text obtained from the first decoder at a time point preceding a target time point, if a time point at which the training target embedding is applied to the first decoder is the target time point; and
obtain a training context vector and training second response text by applying the training target embedding and the training first response text to the first decoder, and
wherein the training second response text is applied to a training input of the first decoder at a time point following the target time point.

5. The speech processing apparatus of claim 4, wherein the processor is configured to:
obtain a termination probability associated with whether the obtaining of the training second response text is terminated, by applying the training target embedding and the training context vector to the second decoder; and
determine whether to terminate an operation of obtaining the training second response text, based on comparison between the termination probability and a predetermined value.

6. The speech processing apparatus of claim 5, wherein the processor is configured to:
obtain a loss of the first decoder based on the first decoder and the training second response text, and a loss of the second decoder based on the second decoder and the termination probability, on a basis of a response generating model including the first decoder and the second decoder; and
train the response generating model based on the loss of the first decoder and the loss of the second decoder.

7. The speech processing apparatus of claim 1, wherein the processor is configured to:
obtain a temporary output by applying the target embedding and the context vector to the second decoder; and
determine whether to terminate the operation of obtaining the response text, based on comparison between the temporary output and a predetermined value.

8. The speech processing apparatus of claim 1, wherein the processor is configured to:
convert the response text into a speech and output the speech to a user entering the target data.

9. The speech processing apparatus of claim 1, wherein the processor is configured to:
obtain utterance intent of the response text by applying the response text to an utterance intent prediction model based on obtaining the response text;
obtain action data by applying the utterance intent to an action database according to the utterance intent; and
transmit the action data to a robot connected to the speech processing apparatus.

10. A speech processing method, the method comprising:
obtaining a target embedding including a feature of target data by applying the target data associated with a speech to a speech processing model trained to output a feature of a signal as a number;
obtaining a context vector and response text estimated as text of the target data by applying the target embedding to a first decoder trained to output a probability of text based on an attention mechanism;
determining whether an operation of obtaining the response text is terminated, by applying the target embedding and the context vector to a second decoder trained to determine whether an embedding is terminated; and
outputting the response text based on whether the response text and the target embedding are terminated.

11. The method of claim 10, wherein outputting the response text comprises:
obtaining training noise data based on at least one of first sub-noise data obtained in target space, or second sub-noise data generated based on a standard normal distribution, or any combination thereof;
obtaining training speech data based on at least one of first sub-speech data recorded by a user, or second sub-speech data generated based on a speech synthesis model, or any combination thereof;
generating training target data through SNR mixing of the training noise data and the training speech data; and
obtaining a training target embedding by applying the training target data to the speech processing model.

12. The method of claim 11, wherein outputting the response text comprises:
obtaining a first temporary output by applying the training target embedding to a text decoder;
obtaining a second temporary output by applying the training target embedding to a speech activity decoder; and
training the speech processing model through a first loss based on the first temporary output and the text decoder, and a second loss based on the second temporary output and the speech activity decoder.

13. The method of claim 11, wherein outputting the response text comprises:
identifying training first response text obtained from the first decoder at a time point preceding a target time point, if a time point at which the training target embedding is applied to the first decoder is the target time point; and
obtaining a training context vector and training second response text by applying the training target embedding and the training first response text to the first decoder, and
wherein the training second response text is applied to a training input of the first decoder at a time point following the target time point.

14. The method of claim 13, wherein outputting the response text comprises:
obtaining a termination probability associated with whether the obtaining of the training second response text is terminated, by applying the training target embedding and the training context vector to the second decoder; and
determining whether to terminate an operation of obtaining the training second response text, based on comparison between the termination probability and a predetermined value.

15. The method of claim 14, wherein outputting the response text comprises:
obtaining a loss of the first decoder based on the first decoder and the training second response text, and a loss of the second decoder based on the second decoder and the termination probability, on a basis of a response generating model including the first decoder and the second decoder; and
training the response generating model based on the loss of the first decoder and the loss of the second decoder.

16. The method of claim 10, wherein outputting the response text comprises:
obtaining a temporary output by applying the target embedding and the context vector to the second decoder; and
determining whether to terminate the operation of obtaining the response text, based on comparison between the temporary output and a predetermined value.

17. The method of claim 10, wherein outputting the response text comprises
converting the response text into a speech and outputting the speech to a user entering the target data.

18. The method of claim 10, wherein outputting the response text comprises:
obtaining utterance intent of the response text by applying the response text to an utterance intent prediction model based on obtaining the response text;
obtaining action data by applying the utterance intent to an action database according to the utterance intent; and
transmitting the action data to a robot connected to a speech processing apparatus.

19. A speech processing apparatus comprising:
a processor; a memory storing at least instructions; and a communication device; wherein the instructions, when executed by the processor, cause the speech processing apparatus to:
receive, via the communication device, target data comprising speech audio input;
process the target data using a speech processing model to generate a target embedding including numerical features representing the speech audio input;
generate, using a first decoder, a context vector and response text based on the target embedding, wherein the response text corresponds to a textual interpretation of the speech audio input;
determine, using a second decoder and based on both the target embedding and the context vector, a termination indicator;
stop generating additional response text when the termination indicator satisfies a termination criterion; and
output the response text via at least one output mechanism of the speech processing apparatus;
wherein the speech processing apparatus processes the speech audio input without requiring an intermediate complete text transcription of the speech audio input.

20. The speech processing apparatus of claim 19, wherein the speech processing apparatus is communicatively coupled to a connected device, and wherein the instructions, when executed by the processor, further cause the speech processing apparatus to:
determine an utterance intent by analyzing the response text;
retrieve, from an action database, action data corresponding to the utterance intent; and
performing, based on one or more of the response text or the action data, at least one of:
displaying the response text on a display device,
converting the response text to audio output to be transmitted by the communication device, or
executing a command based at least in part on the response text by sending a control signal via the communication device to the connected device.
